(19) United States
(12) Patent Application Publication
(10) Pub. No.: US 2013/0176113 A1
(43) Pub. Date: Jul. 11, 2013

(54) WIRELESS BIDIRECTIONAL INFORMATION INTERCHANGE SYSTEM

(71) Applicant: Jason Mallin, Merrick, NY (US)

(72) Inventor: Jason Mallin, Merrick, NY (US)

(21) Appl. No.: 13/736,736

(22) Filed: Jan. 8, 2013

Related U.S. Application Data
(60) Provisional application No. 61/631,618, filed on Jan. 9, 2012.

(51) Int. Cl. G06K 7/01

(52) U.S. Cl. CPC G06K 7/01
USPC 340/10.1

(57) ABSTRACT

An RFID enabled information delivery system utilizes readable RFID tags which are attached to particular buildings, utilities, services, products, equipment and/or appliances. A user scans the RFID tag with a handheld device to obtain data unique to that item. That data is wirelessly transmitted from the handheld device to an information clearinghouse server. The information clearinghouse also receives detailed information from the product manufacturers' or service providers' information management system. The information clearinghouse server compares and matches the RFID data to the detailed information and wirelessly transmits the matched item-specific information back to the user's handheld device, thus immediately supplying the user with extensive information relating to the exact building, utility, service, product, equipment and/or appliance. The handheld device is equipped with a software application that graphically and textually displays the expansive and detailed data on a display screen.

### RELATED APPLICATION

This patent application is related to provisional patent application Ser. No. 61/631,618 entitled “Wireless Bidirectional Information Interchange System” filed on Jan. 9, 2012, priority from which is hereby claimed.

### FIELD OF THE INVENTION

The present invention relates to a system of RFID tags and RFID reading enabled devices for use in the immediate delivery and acquisition of specific and detailed building, utility, service, equipment, product and/or appliance information. The invention further relates to the system's bidirectional communication functionality in which the specific data is wirelessly transmitted between components of the system.

### BACKGROUND OF THE INVENTION

The conventional method of providing important information to a third party who needs such information (for example, providing building plans or equipment specs and service records to utility or emergency workers at the work site) is via printed documents which must be obtained from individuals or organizations off site who may not be available at the time the information is needed and which are easily damaged and lost. Delays in obtaining such information can be costly and even dangerous, in the context of emergency responders requiring building plans to rescue occupants of a threatened structure.

In another context, the conventional method of providing manufacturers' product, article, or equipment information pertaining to assembly, operation, registration, warranties, customer service, and repair are either printed manuals included with the product or service at time of sale or via the manufacturers' websites. However, printed product manuals may be lost with time, discarded due to lack of space or simply not included with the purchased item. Further, important product information concerning installation, operation and updates, which may be downloaded from a website to a computer, is frequently not readily available where there is direct access to the product. Additionally, there is limited ability of the manufacturer to convey important product information after that product is installed.

Currently, there are many products in place to improve building safety. Such products include smoke detectors, fire suppression systems, backup generators for emergency lighting and elevator function, HVAC duct dampers, and automatic door closers to prevent the spread of fire or smoke. Additionally, many utilities and utility components, such as electrical wiring, gas lines, and plumbing, and sanitation systems have been upgraded, modified during renovation, or completely replaced since initial installation. Since structures undergo multiple renovations making the original plans, blueprints, schematics, and diagrams obsolete, there rarely is any information available on-site as to the status and layout of these systems. Further, these modernizations require local approval and time-consuming inspections prior to being put in use.

Public building information is often required by emergency first responders, fire-rescue, paramedics, and law enforcement to safely enter a building and perform their required functions. Should a building emergency such as a fire, smoke condition, partial collapse, or natural disaster occur, emergency first responders require immediate access to system and utility information and schematics to quickly address the problem. In addition, information concerning renovation updates and clear passageways as well as accessory components such as junction boxes, shut off valves, and overhead conduits are critical for emergency rescue personnel. During emergencies every second counts and the ability to obtain building plans, blueprints, schematics, and diagrams for multiple areas of the building is cumbersome, time-consuming, and often dangerous. In the frequent case when necessary information is not stored on site, emergency personnel will waste precious time coordinating with third parties to acquire the needed records.

Therefore, there is a need in the art for a wireless system of delivering building, utility, service, equipment, product and/or appliance information instantly to the handheld devices of on-site contractors, law enforcement, and emergency personnel when they face emergency situations in real time, without requiring a person to search for the information at the various locations it might be available.

### SUMMARY OF THE INVENTION

In order to solve the need in the art for a wireless system of instantly delivering building, utility, service, equipment, product and/or appliance information to the handheld devices of contractors, law enforcement, and emergency personnel when they face emergency situations, the present invention has been devised.

One embodiment of the present invention is a wireless bidirectional information system designed to provide detailed and specific information using an RFID-enabled process at the direct point of access to consumer products, commercial equipment, utility and utility components, infrastructure building entrances, and/or other areas where critical emergency information is needed. More specifically, the invention utilizes a custom software application on an end user's handheld device to immediately access manufacturer and service provider databases to procure product information, essential building utility schematics, and building blueprint access. The invention is especially useful for first responders in emergency situations.

The following example illustrates the invention's usefulness: large pieces of equipment such as transformers, generators, pumps, cranes, and construction vehicles are located in varying external locations exposing them to extreme environmental conditions where paper based information cannot be stored or maintained. These complicated units require repair or replacement by crews not necessarily familiar with the details of the particular unit therefore requiring a higher level of product information access. The current invention solves these issues as it includes wireless transmission of specific product-based number, code, or identifier embedded in a dynamic tag making on-site maintenance fast, efficient, and free of cumbersome written materials. Further, the dynamic tag's small physical size and few parts allow it to be exposed in severe weather with little risk of corrosion or malfunction. Typically, the dynamic tag will employ RFID technology. Emergency crews simply need to use their handheld devices, equipped with a custom software application to “read” the dynamic/RFID tag, and all relevant product or equipment information will immediately appear on the device's display screen. The specific building, utility, service, equipment, product and/or appliance information is readily available without the need to retrieve printed literature or conduct tiresome web searches.

This invention was developed with a focus on the urgent need for immediate, on-site acquisition of data. Technicians involved in utility repair work in the field require a means of procuring complex utility or equipment data, as well as a means to ensure this data is always current. Therefore, the present invention has use in repair and maintenance projects as well as emergency situations. Contractors can quickly obtain building schematics, view prior repair projects and record data for building code enforced service updates through use of this invention.

Ultimately, this embodiment of the present invention instantly provides up-to-date manufacturer specific building, utility, service, equipment, product and/or appliance information to a handheld device utilizing a wireless RFID enabled system. Primary components of the system include: a dynamic tag or label with a previously embedded readable component, such as a unique RFID number, code, or identifier specific to the intended building, utility, service, equipment, product and/or appliance; participating manufacturer or service provider information management systems—i.e. databases storing all relevant information about the particular building, utility, service, equipment, product and/or appliance—complete with the capability of transmitting the information; and a software application installed on a handheld device which enables that handheld device to scan the dynamic tag, transmit the readable component, and receive the information transmitted by the databases.

Additionally, the system employs the use of a handheld device such as a smart phone or tablet computer, preferably equipped with wireless communication and ability to scan the readable component from the dynamic tag; an information clearinghouse server which receives the readable component from the handheld device and detailed product information from the information management system/database, compares the two sets of data, and transmits the matched data back to the handheld device; and wireless communication between the handheld device and information clearinghouse server such that information is transferred back and forth in a bidirectional fashion.

The dynamic tags contain a unique identification number or code embedded in the tag. They are dynamic in the sense that they can transmit data to a separate device that scans the tag and reads the embedded number, code, or identifier. Preferably, the tags employ RFID technology as a means of transmitting the data. A device with RFID readable capabilities must read the dynamic tag in order for the data to be transferred; in other words, the unique number, code, or identifier is a “readable component.” RFID components of the tags may either be passive RFID or active RFID. In any case, the dynamic tag is attached to the building, utility, service, equipment, product and/or appliance and positioned such that the emergency responder or other end user can easily scan it with the separate device. Furthermore, the affixed RFID tag at the determined location will be based on its exposure specifications to assure its operability. The RFID tags have the ability to withstand harsh environments and are useful in implementing this embodiment of the invention in environments with unusual weather patterns and in systems involving harsh weather applications.

In some embodiments, a unique geopositional coordinate identifier component of the tag will be set up at the tags initiation, so if the tag is purposely moved from its current position by theft, the unique position change terminates the tag's functionality, therefore prohibiting the successful “reading” of the tag by an unauthorized user's mobile device. The bidirectional communication system may employ the RFID's efficient read/write capability which allows for smooth data updating for utilities that require constant maintenance such as telephone pole shared space and repair history on oil and gas pipelines, boilers, and air conditioning repair.

In addition to RFID enabled tags, dynamic tags that employ technology meeting the ISO/IEC 14443 standard may also be used. The ease of accessing an ISO/IEC 14443 standard enabled tag by mobile device means an ISO/IEC 14443 standard tag is just as effective as RFID for sharing data and updates regarding repairs, inspections, and maintenance. In the alternative, Ultra High Frequency (UHF), Very High Frequency (VHF), and other high frequency standards may be used in dynamic tag data transmission.

The current invention may employ a device that connects to the internet via a hardwire connection, but in an emergency situation, or for appliances and systems located outside, first responders will unlikely have the time to search for a hardwire port. Further, bulky laptop computers and scan devices may have the ability to read the tags, but access to a smaller handheld device, such as a smartphone or tablet, is preferred, albeit not required. Accessing narrow passageways in the event of an emergency requires the use of more compact, transportable devices. In light of these potential restrictions, the preferred embodiment requires a handheld device with RFID reading capability in wireless communication with the internet. Therefore, the handheld device should include an RFID antenna to ensure RFID reading capability. If the dynamic tag employs another type of wireless technology, such as VHF or UHF, then the handheld device's antenna should be accordingly configured. Should the user wish to refer to the obtained information at a later time, the device may have sufficient internal memory to store any and all information obtained by the manufacturer databases, including high-memory graphical data like blueprints and schematics, as well as more text-based data like spreadsheets and hazard documents.

The software application instructs the handheld device to activate its RFID antenna, read the RFID tag, and transmit the readable component to the information clearinghouse server. The application also instructs the handheld device to accept expansive amounts of data regarding the scanned building, utility, service, equipment, product and/or appliance after the information clearinghouse server transmits it back. Typically, the application manages these transmissions through use of a user-friendly interface displayed on the handheld device's visual screen. When activated, the application displays a “search” image on the screen. However, in the event of time-crucial emergencies, the application may be customized to instantaneously read the dynamic tag and transmit the unique RFID number without the requirement of a user input. Further, the software application provides a visual display of all blueprints, schematics, spreadsheets, hazard information, user manuals, product literature, engineering documentation, and other information relevant to the building, utility, service, equipment, product and/or appliance. The application provides the end user with a graphical and textual representation of the critical information immediately after a scan of the dynamic tag. After the desired information is obtained, the application gives the user the option to store the information on the device's internal memory.

The wireless communication between the handheld device and information clearinghouse server must have data interchange capability. For optimal performance, the handheld device should employ a carrier capable of sending and receiving transmissions as in WIFI, G3, or G4. Preferably, the carrier has pervasive regional and national reach and a record of high reliability and strong signal strength.

The information clearinghouse server performs the matching of the scanned readable component data to the information transmitted by the manufacturer database and/or information management system. Once a match is made, the information clearinghouse server transmits the detailed product, appliance, utility, service, or building information back to the user's handheld device. In an alternate embodiment, the information clearinghouse server, and not the manufacturer database and/or information management system, provides a repository of manufacturer product, appliance, utility, service, or building information.

The information management systems, i.e. manufacturer databases, are the manufacturer-driven components of the wireless bidirectional information interchange system. Product manufacturers and service providers store all relevant product, appliance, utility, service, or building data on their respective information server databases. Data uploads are made continually as products, appliances, utilities, services, and buildings are continually updated and modified throughout time. These databases then send the specific literature, product manual, documentation, schematics, blueprints, and other relevant data to the clearinghouse server where it is matched against the scanned RFID number or other readable component.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an overview of the top-level system components of the present invention.

FIG. 2A is an illustration of the initial, front-end components of the present invention.

FIG. 2B is an illustration of the final, back-end components of the present invention.

FIG. 3 is an illustration of the initial, front-end components and sub-components of the handheld device of the present invention.

FIG. 4 is an overview of options for information capture of the present invention

FIG. 5 is an overview of the system that addresses problem solving of the present invention.

### DESCRIPTION OF THE PREFERRED EMBODIMENT

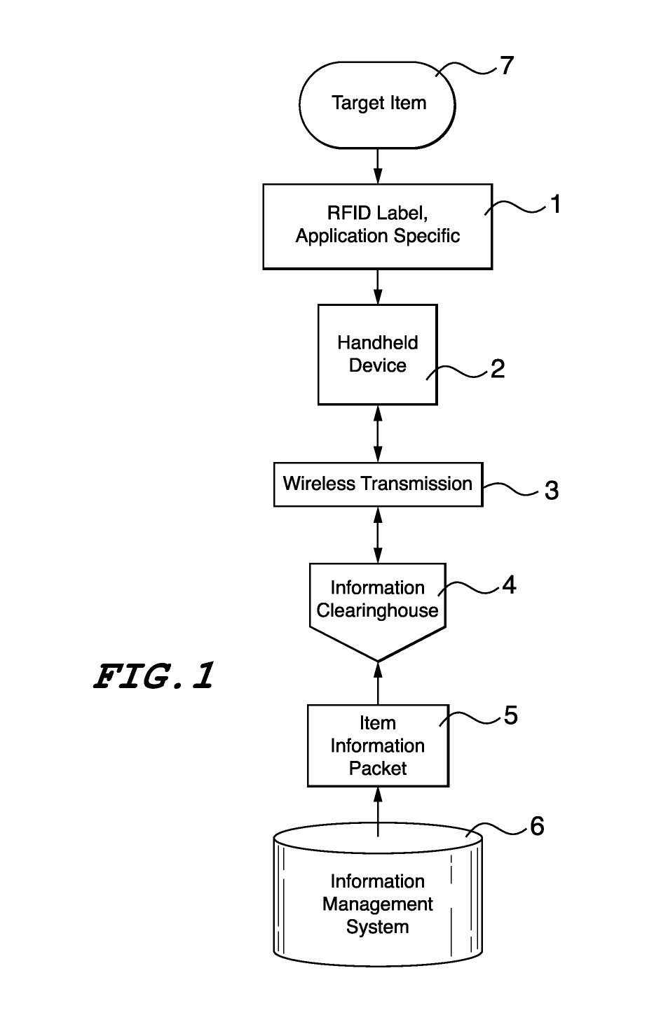

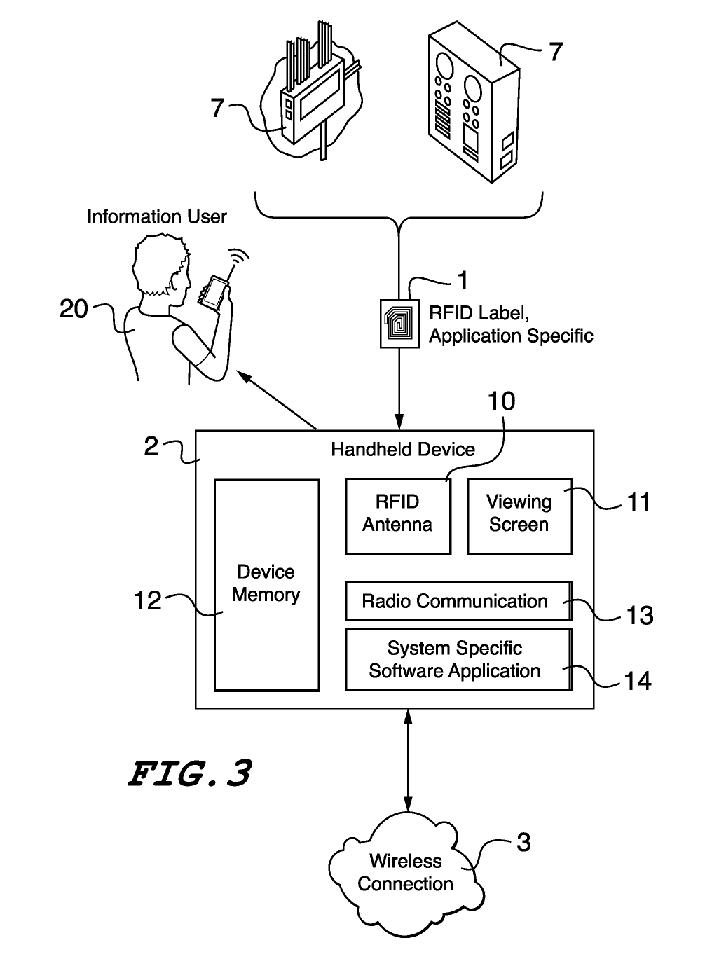

Referring now to FIG. 1, a dynamic tag 1 with a readable component is affixed to the target building, utility, service, equipment, product and/or appliance 7 such as a consumer product, commercial equipment, utility panel, or building entrance. Preferably, the readable component contains RFID data; specifically, a unique RFID number which identifies the exact product, appliance, service, utility, building or other target building, utility, service, equipment, product and/or appliance 7 to which the RFID tag 1 is attached. The RFID data may also be passive RFID or active RFID. The manufacturer records the unique RFID number or any other data in the form of a readable component required to identify the specific target building, utility, service, equipment, product and/or appliance 7 in its information management system (i.e. manufacturer database) 6. A handheld device 2 with wireless communication and RFID read capabilities scans the RFID tag 1. The unique RFID number is captured utilizing the handheld device 2's RFID read capability managed by the previously installed software application 14 as depicted in FIG. 3.

Referring again to FIG. 1, the handheld device 2 sends the scanned RFID number and associated data via wireless transmission 3 to the information clearinghouse 4. The information management system 6 transmits detailed item information packet 5 about its products, appliances, services, utilities, and buildings, to the information clearinghouse 4. The information clearinghouse 4 compares the RFID number and other data transmitted by the handheld device 2 and compares it against the expansive building, utility, service, equipment, product and/or appliance information 5 it has received. After the RFID number is matched to the expansive information 5, the information clearinghouse 4 transmits the detailed information 5 back to the handheld device 2.

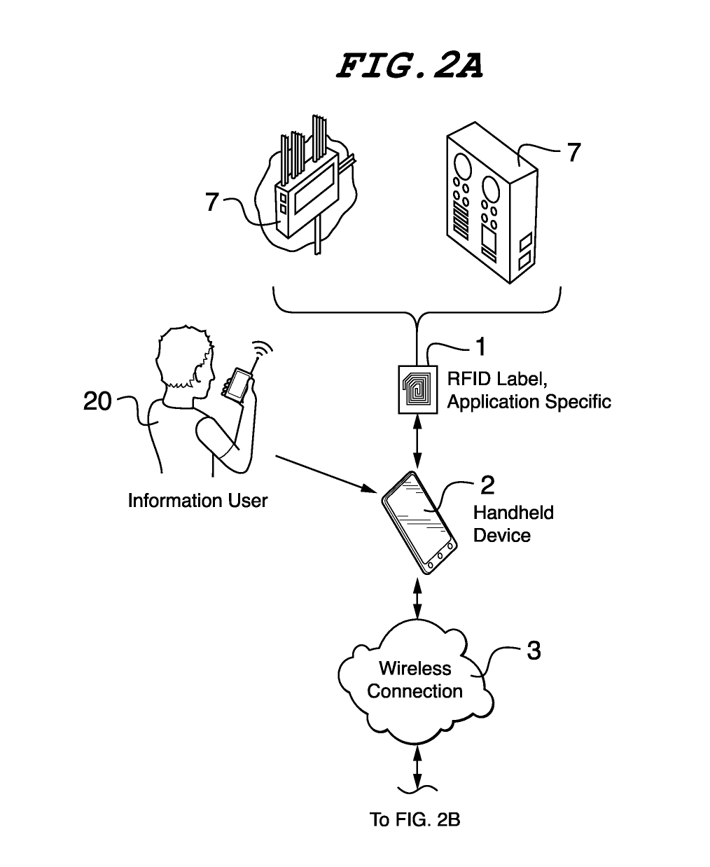

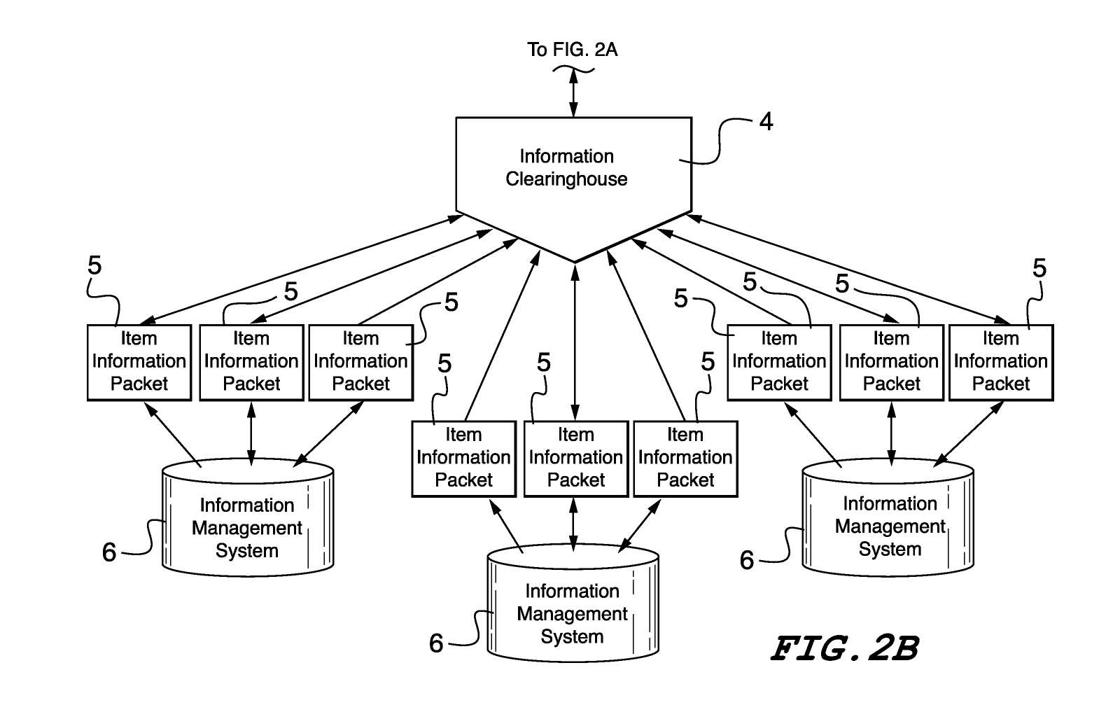

FIG. 2A, FIG. 2B, and FIG. 3 present a more detailed illustration of the elements and dynamic flow of building, utility, service, equipment, product and/or appliance information through the invention. To obtain information about a specific building, utility, service, equipment, product and/or appliance 7, the RFID tag 1 is located by the user 20. The RFID antenna 10 enables the handheld device 2's RFID read capability and the radio communication means 13 enables wireless communication. The handheld device 2 also contains a display screen 11 capable of displaying textual and graphical representations of the received information packets 5. On board memory 12 is sufficient to store specific information packets 5 for retrieval at a later time even when the user 20 is not in proximity with target building, utility, service, equipment, product and/or appliance 7. The radio communication means 13 may support various wireless carriers such as WIFI and many different communication protocols such as 3G and 4G.

Additionally, the handheld device 2, through use of its RFID antenna 10, contains a software utility application 14 which captures the RFID number when brought into proximity of the RFID tag 1. The handheld device 2 may contain several different software utility applications 14, each specific to the particular building, utility, service, equipment, product and/or appliance being scanned; however, in the preferred embodiment, a universal software application 14 is installed. The software utility application 14 initiates the handheld device 2 to display a message confirming that RFID tag 1 was scanned on the display screen 11 and then activates the radio communication means 13 so the handheld device 2 may engage in wireless communication 3. The handheld device 2 transmits the RFID number automatically once it scans the RFID tag 1. In an alternate embodiment, it waits for an instruction from the user 20 via the software application 14's user-friendly interface. If the handheld device 2 is configured to not automatically transmit the RFID number, the user 20 can choose when to transmit it by pressing buttons or inputting commands into the interactive software application 14's interface.

The readable RFID data is sent to the information clearinghouse server 4 via wireless communication 3. The information clearinghouse server 4 matches the unique RFID product number from RFID tag 1 with the extensive building, utility, service, equipment, product and/or appliance information 5 sent by the manufacturer's information management system 6. The information clearinghouse server 4 transmits the detailed item information packets 5 via wireless communication 3 back to the handheld device 2 where it is displayed on the display screen 11 and/or stored in device memory 12.

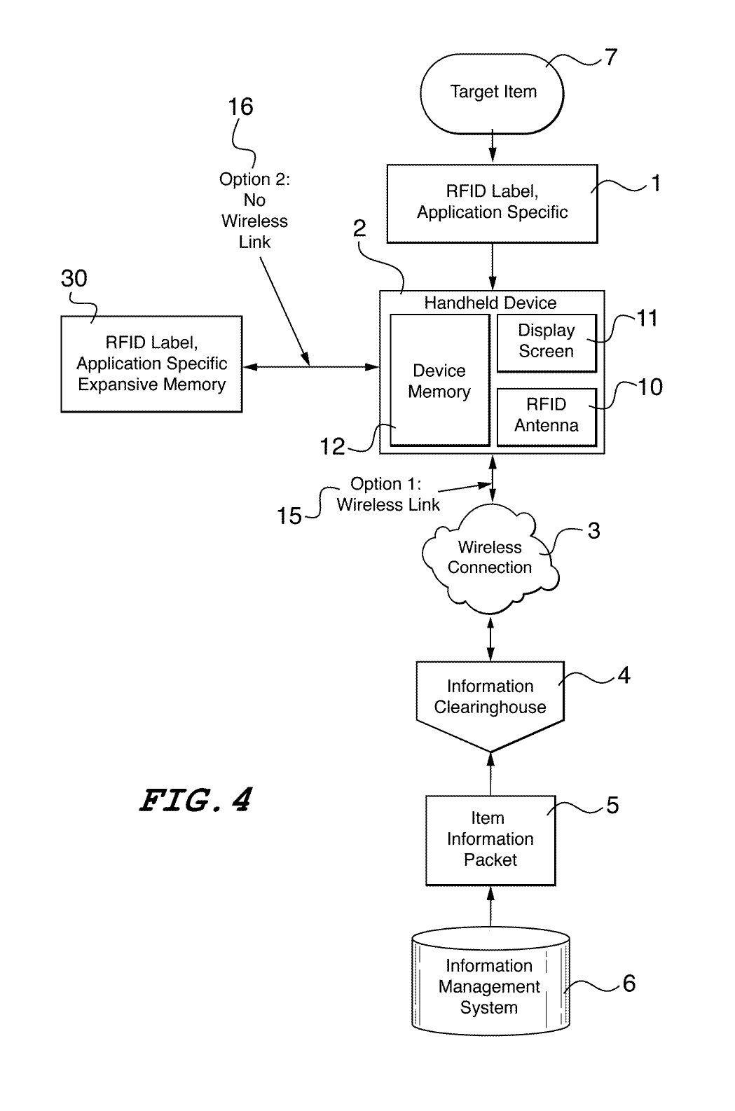

FIG. 4 depicts two alternative options for building, utility, service, equipment, product and/or appliance information access. Both options are based on an application specific RFID tag 1 containing a readable RFID tag component and a handheld device 2 with RFID read capability, display screen 11, internal device memory 12 sufficient to retain the manufacturer's item information packets 5.

Reference numeral 15 refers to alternative Option 1. Option 1 provides an alternative illustration of the embodiment as previously disclosed: the wireless communication link 3 to the information clearinghouse server 4 receives the item information packets 5 from information management system 6. Using the invention's bidirectional capability, the information clearinghouse server 4 matches the item information to the readable RFID component and transmits the matched data back via the wireless connection 3 to handheld device 2.

In contrast, FIG. 4 also depicts an alternative information access means marked Option 2. Reference numeral 16 refers to alternative Option 2, which does not utilize a wireless communication link 3 between components. Further, the RFID tag, which had very limited memory in previously described embodiments, in this alternate embodiment has sufficient memory to store basic information about the building, utility, service, equipment, product and/or appliance, such as buyer name and address, sale date, and sale location. FIG. 4 depicts this high-capacity tag as the RFID tag with expansive memory 30. In another alternate embodiment, the RFID tag with expansive memory 30 has enough memory to store any and all relevant building, utility, service, equipment, product and/or appliance information packets 5. The embodiment disclosed in Option 2 does not utilize wireless data transmissions; instead, the handheld device 2 reads RFID tag with expanded memory 30 and all detailed item information packets 5 are instantly uploaded. There is no need for wireless communication link 3 with the information clearinghouse server 4 and/or information management system 6.

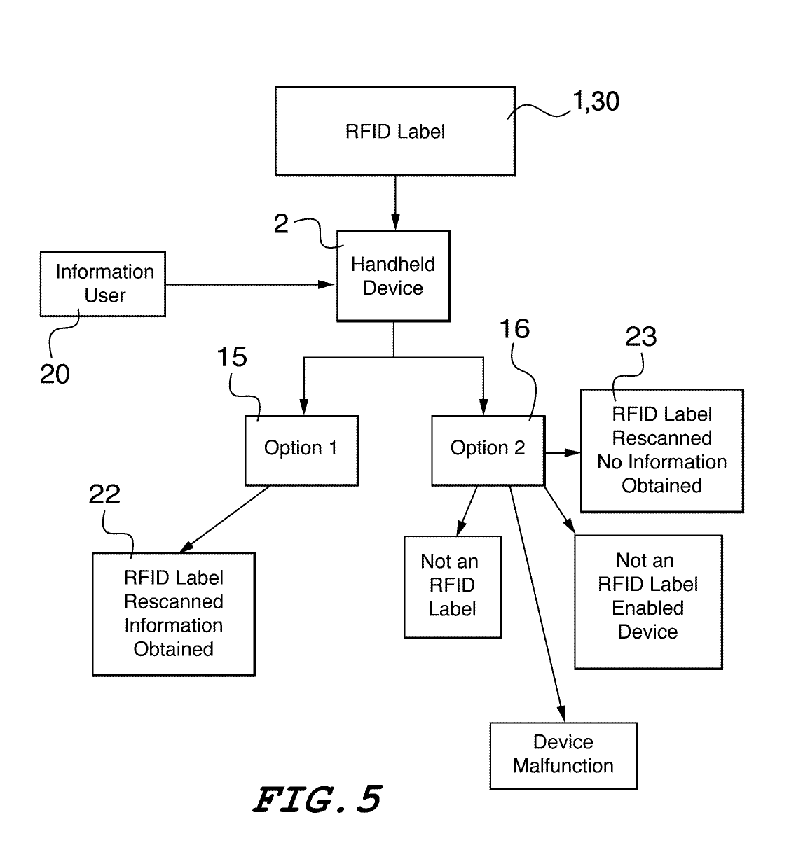

FIG. 5 diagrams the way the system of the preferred embodiment handles the possibility of not acquiring an RFID number from an RFID tag 1, 30 by a suitably equipped handheld device 2. If a user 20 does not obtain the necessary RFID information via Option 1, he should use the handheld device 2 to rescan the RFID tag 1, 30 as depicted in reference numeral 22. If this does not solve the problem, the user 20 is encouraged to contact his wireless communication 3 carrier or contact the building, utility, service, equipment, product and/or appliance manufacturer or service provider directly. Should the handheld device 2 not capture the detailed information 5 in Option 2, the handheld device 2 should be repositioned in the proper range and attempt to rescan the RFID tag with expanded memory 30 as depicted in reference numeral 23. If the inability to capture the detailed information 5 persists, the user 20 may not be scanning an RFID tag with expanded memory 30 (or an RFID tag of any kind), or the handheld device 2 does not have RFID read capability. In the case of an improperly equipped handheld device 2, the user 20 is encouraged to install an appropriate system utility application that can manage RFID scans and transmissions. If upon rescanning the RFID tag 1, 30 no RFID number is captured, the user 20 is advised to contact the item's manufacturer or service provider to obtain the item information 5 by alternative means.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for delivering article or structure information to an end user, comprising:
a dynamic tag, wherein said tag is attached to an article or structure which the user seeks information specific to said article or structure, and
said tag is encoded with a readable component, wherein said readable component identifies the specific article or structure;
a database wherein information specific to said article or structure is stored; and
a software application for installation on a user device, wherein said application enables said user device to read said tag, said application enables said user device to transmit said readable component, and said application enables said user device to receive said information specific to said article or structure.

2. The system of claim I further comprising an information clearinghouse server which receives said readable component from said user device, receives said information specific to said article or structure from said database, matches said readable component to said information specific to said article or structure, and transmits said information specific to said article or structure that matched said readable component to said user device.

3. The system of claim l wherein said database receives said readable component from said user device, matches said readable component to said information specific to said article or structure, and transmits said information specific to said article or structure that matched said readable component o said user device.

4. The system of claim I wherein said application enables said user device to display said information specific to said article or structure.

5. The system of claim 1 wherein said user device has memory sufficient to store said information specific to said article or structure.

6. The system of claim I wherein said user device is a mobile device such as a handheld device, a smart phone, a tablet, or a laptop computer.

7. The system of claim 1 wherein said application enables said user device to wirelessly transmit said readable component and wirelessly receive said information specific to said article or structure.

8. The system of claim 7 wherein said application enables said user device to wirelessly transmit said readable component and wirelessly receive said information specific to said article by radio communication such as WWI or by communication protocol such as 3G or 4G.

9. The system of claim I wherein said readable component is data that represents a unique RFID number or unique RFID code.

10. The system of claim 1 wherein said readable component employs technology meeting the ISO/IEC 14443 mobile standard, high frequency standard, UHF standard, or VHF standard.

11. The system of claim 1 wherein said article or structure is outside.

12. A system for delivering article or structure information to an end user, comprising:
a dynamic tag, wherein said tag is attached to an article or structure which the user seeks information specific to said article or structure, and said tag is encoded with a readable component, wherein said readable component identifies the specific article or structure, and said information specific to said article or structure is stored on said tag; and
a software application for installation on a user device, wherein said application enables said user device to read said tag.

13. The system of claim 12 wherein said application enables said user device to display said information specific to said article or structure.

14. The system of claim herein said user device has memory sufficient to store said information specific to said article or structure.

15. The system of claim 12 wherein said user device is a mobile device such as a handheld device, a smart phone, a tablet, or a laptop computer.

16. The system of Blair 12 wherein said application enables said user device to wirelessly transmit said readable component and wirelessly receive said information specific to said article or structure.

17. The system of claim 16 wherein said application enables said user device to wirelessly transmit said readable component and wirelessly receive said information specific to said article by radio communication such as WIFI or by communication protocol such as 3G or 4G

18. The system of claim 12 wherein said readable component is data that represents a unique REID number or unique RFID code.

19. The system of claim 12 wherein said readable component employs technology=meeting the ISO/IEC 14443 mobile standard, high frequency standard, UHF standard, or VHF standard.

20. The system of claim 12 wherein said article or structure is outside.
